(19) United States
(12) Patent Application Publication
(10) Pub. No.: US 2022/0078288 A1
(43) Pub. Date: Mar. 10, 2022

(54) MULTISOURCE CLIENT ATTRIBUTION

(71) Applicant: Derek Iorg, Salt Lake City, UT (US)

(72) Inventor: Derek Iorg, Salt Lake City, UT (US)

(21) Appl. No.: 17/470,814

(22) Filed: Sep. 9, 2021

Related U.S. Application Data
(60) Provisional application No. 63/076,375, filed on Sep. 9, 2020.

(51) Int. Cl. H04M 11/00; G06F 9/451; G06Q 30/06; G06F 40/174

(52) U.S. Cl. CPC H04M 11/00; G06F 9/451; G06Q 30/0643; G06F 16/90335; H04M 2203/256; H04M 2203/1058; G06F 40/174

(57) ABSTRACT

Apparatuses, systems, methods, and computer program products are presented for multisource client attribution. A hardware server computing device monitors requests for a website over a data network, voice calls associated with the website, and user form interactions associated with the website. The server determines a source from which the user arrived at the website and associates the source with the user. The server associates one or more data elements of a voice call with the user. The server associates data of a user form interaction with the user. The server presents a graphical user interface to a second user, including the source, the one or more data elements of the voice call, the data of the user form interactions, and one or more user interface elements enabling the second user to perform one or more actions related to the user.

### FIELD

This invention relates to online advertising and more particularly relates to attribution of online clients obtained from multiple sources.

### BACKGROUND

Many online analytics tools show incomplete or partial information, making it difficult for users to track the source of leads and/or clients. For example, some online analytics tools may track leads from one source (e.g., an online advertising campaign), but may be unable to track other sources (e.g., web search, online chat, phone calls, or the like).

### BRIEF SUMMARY

Apparatuses, systems, methods, and computer program products are disclosed for multisource client attribution. An apparatus, in one embodiment, includes a hardware server computing device comprising a processor and a non-transitory computer readable storage medium storing program code executable by the processor to perform operations. An operation, in some embodiments, includes monitoring requests for a website over a data network, voice calls associated with the website, and/or user form interactions associated with the website. In certain embodiments, an operation includes, in response to a request for the website from a hardware computing device for a user, determining a source from which the user arrived at the website and associating the source with the user. An operation, in a further embodiment, includes, in response to receiving a voice call from a hardware computing device for the user, associating one or more data elements of the voice call with the user. In one embodiment, an operation includes, in response to detecting a user form interaction from a hardware computing device for the user, associating data of the user form interaction with the user. An operation, in a further embodiment, includes presenting a graphical user interface to a second user associated with the website on an electronic display device, the graphical user interface comprising the source associated with the user, the one or more data elements of the voice call with the user, the data of the user form interaction with the user, and/or one or more user interface elements enabling the second user to perform one or more actions related to the user.

A system, in one embodiment, includes a hardware server computing device comprising a processor and a non-transitory computer readable storage medium storing program code executable by the processor to perform operations. An operation, in some embodiments, includes monitoring requests for a website over a data network, voice calls associated with the website, and/or user form interactions associated with the website. In certain embodiments, an operation includes, in response to requests for the website from hardware computing devices for users, determining sources from which the users arrived at the website and associating the sources with the users. An operation, in a further embodiment, includes, in response to receiving voice calls from hardware computing devices for the users, associating one or more data elements of the voice calls with the users. In one embodiment, an operation includes, in response to detecting user form interactions from hardware computing devices for the users, associating data of the user form interactions with the users. An operation, in a further embodiment, includes presenting a graphical user interface to a different user associated with the website on an electronic display device, the graphical user interface comprising the sources associated with the users, the one or more data elements of the voice calls with the users, the data of the user form interactions with the users, and/or one or more user interface elements enabling the different user to perform one or more actions related to the users. A system, in some embodiments, includes a plurality of client attribution modules executing on hardware computing devices for the users. Client attribution modules, in various embodiments, are configured to store one or more of the sources associated with the users, the one or more data elements of the voice calls with the users, and/or the data of the user form interactions with the users in local non-transitory computer readable storage mediums. In a further embodiment, client attribution modules are configured to periodically upload the one or more of the sources associated with the users, the one or more data elements of the voice calls with the users, and/or the data of the user form interactions with the users to the non-transitory computer readable storage medium of the server computing device in response to one or more trigger events.

Other apparatuses are disclosed for multisource client attribution. In one embodiment, an apparatus includes means for monitoring requests for a website over a data network, voice calls associated with the website, and/or user form interactions associated with the website. An apparatus, in a further embodiment, includes means for determining, in response to requests for the website from hardware computing devices for users, sources from which the users arrived at the website and associating the sources with the users. In some embodiments, an apparatus includes means for associating, in response to receiving voice calls from hardware computing devices for the users, one or more data elements of the voice calls with the users. An apparatus, in certain embodiments, includes means for associating, in response to detecting user form interactions from hardware computing devices for the users, data of the user form interactions with the users. An apparatus, in one embodiment, includes means for presenting a graphical user interface to a different user associated with the website on an electronic display device, the graphical user interface comprising the sources associated with the users, the one or more data elements of the voice calls with the users, the data of the user form interactions with the users, and/or one or more user interface elements enabling the different user to perform one or more actions related to the users.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for multisource client attribution;

FIG. 2 is a schematic block diagram of one embodiment of a graphical user interface;

FIG. 3 is a schematic block diagram illustrating a further embodiment of a system for multisource client attribution;

FIG. 4 is a schematic flow chart diagram illustrating one embodiment of a method for multisource client attribution; and

FIG. 5 is a schematic flow chart diagram illustrating a further embodiment of a method for multisource client attribution.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware computing devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

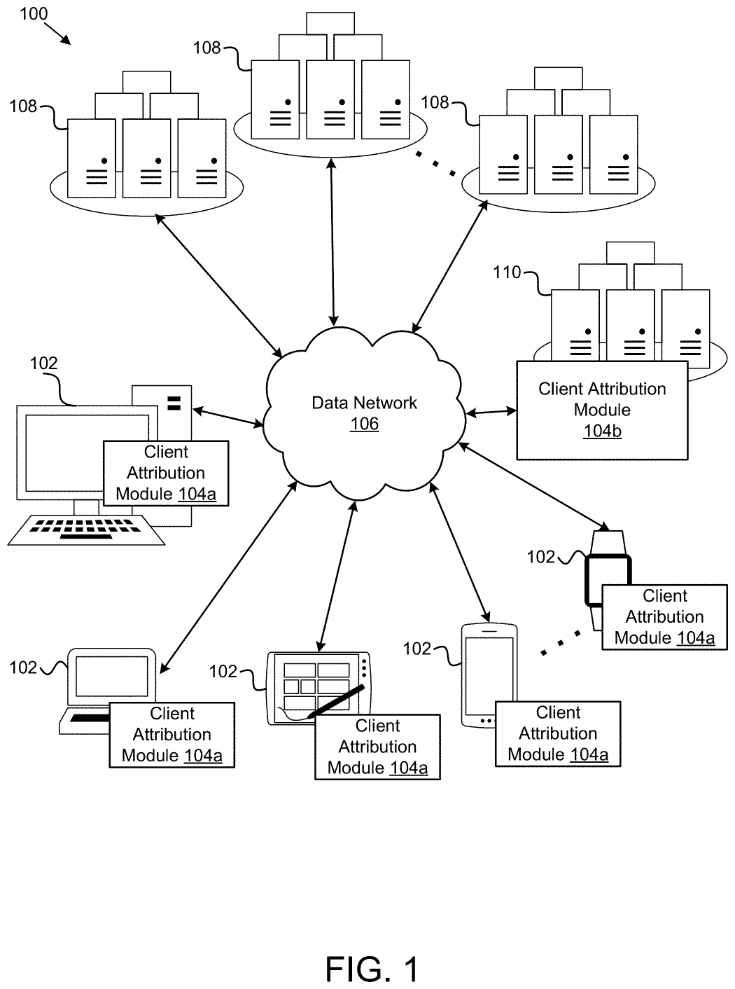

FIG. 1 depicts one embodiment of a system 100 for multisource client attribution. The system 100, in the depicted embodiment, includes one or more hardware computing devices 102, one or more client attribution modules 104 (e.g., a backend client attribution module 104b and/or a plurality of frontend client attribution modules 104a disposed on the one or more hardware computing devices 102), one or more data networks 106 or other communication channels, one or more third-party providers 108 (e.g., one or more servers 108 of one or more third-party providers 108; one or more ecommerce retailers; one or more cloud or network service providers; one or more attorneys or other service providers; or the like), and/or one or more backend server computing devices 110. In certain embodiments, even though a specific number of hardware computing devices 102, client attribution modules 104, data networks 106, third-party providers 108, and/or backend server computing devices 110 are depicted in FIG. 1, one of skill in the art will recognize, in light of this disclosure, that any number of hardware computing devices 102, client attribution modules 104, data networks 106, third-party providers 108, and/or backend server computing devices 110 may be included in the system 100 for multisource client attribution.

In one embodiment, the system 100 includes one or more hardware computing devices 102. The hardware computing devices 102 (e.g., computing devices, information handling devices, or the like) may include one or more of a desktop computer, a laptop computer, a mobile device, a tablet computer, a smart phone, a set-top box, a gaming console, a smart TV, a smart watch, a fitness band, an optical head-mounted display (e.g., a virtual reality headset, smart glasses, or the like), an HDMI or other electronic display dongle, a personal digital assistant, and/or another computing device comprising a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a volatile memory, and/or a non-volatile storage medium. In certain embodiments, the hardware computing devices 102 are in communication with one or more servers 108 of one or more third-party providers 108 and/or one or more backend server computing devices 110 via a data network 106, described below. The hardware computing devices 102, in a further embodiment, are capable of executing various programs, program code, applications, instructions, functions, or the like.

In certain embodiments, a client attribution module 104 may enable third-party providers 108 and/or other users (e.g., online marketers/advertisers, ecommerce vendors, attorneys, accountants, doctors, dentists, or other users) to track new clients, customers, and/or other leads on the internet and/or another data network 106 from multiple sources (e.g., different advertisements, organic search, online chat, voice calls, social networks, landing pages, referrals from other third-party providers 108, or the like). A client attribution module 104 may provide a single interface for a user to track clients, customers, and/or other leads from different sources (e.g., a graphical user interface (GUI), a website or other online interface, an application program interface (API), or the like). In this manner, in some embodiments, a client attribution module 104 may enable a user to make optimal marketing and/or other decisions based on the different sources for the user's leads.

A client attribution module 104, in one embodiment, may comprise custom JavaScript code and/or other computer executable program code (e.g., that executes in a browser on the one or more hardware computing devices 102, that executes on a hardware server computing device 110, or the like) that assigns each user (e.g., of one or more websites or other sources) a unique identifier. A client attribution module 104 may track a unique identifier for a client so that it follows the client for at least a predefined expiration period of time (e.g., a week, a month, two months, three months, four months, five months, six months, a year, or the like), or until the client triggers a predefined engagement event (e.g., signs up, makes a purchase, becomes a lead, or the like). In response to a client filling out a form, making a voice call, using an online chat, or the like, a client attribution module 104 may add the client's information to a data store (e.g., a file, a database, a spreadsheet, a document, or the like) such that a user may look up the clients they acquire, see which ad, referring URL, organic search, voice call, or other source from which the client was originally referred to their website, other interactions with the client, actions the client performed, or the like, since the client's initial visit or other interaction.

A client attribution module 104 may substantially seamlessly integrate tracking of voice calls, online chats, web forms, and the like, allowing them each to be tracked and/or managed within the same dashboard or other interface. Regardless of how a user engages as a client, a client attribution module 104 may provide a user with relevant data on where the user came from allowing the user to ascertain which advertising budget allocations are most effective, or the like. Instead of only tracking a total number of leads, or the like, in some embodiments, a client attribution module 104 may show which leads became clients, a source for each lead, and/or other relevant information for each lead.

In order to track sources for leads and/or clients, a client attribution module 104 may comprise JavaScript code or other computer executable program code to monitor incoming clients, to communicate with third-party software and/or services, to trace clients back to origination accurately (e.g., to an advertisement or the like, by manipulating a referring URL to reference a unique identifier, or the like), to gather lead information as a client interacts with a website (e.g., to track a history of a lead as they engage as a client, purchase one or more goods and/or services, or otherwise convert), or the like. For example, in response to a user entering a site, a client attribution module 104 may assign the user a unique identifier and begin tracking the user. A client attribution module 104 may track actions for the user (e.g., a click, exit, form fill, chat, or the like), and write the tracked action back to a database or other data store. In response to a user entering the site, a client attribution module 104 may store a referral URL with the unique identifier for the user, allowing the client attribution module 104 to track how the user arrived at the site, and to accurately attribute the user to the correct marketing and/or referral source.

A client attribution module 104 may use a database or other data store to populate a client dashboard or other graphical user interface (GUI). A dashboard user may log into a dashboard provided by a client attribution module 104, and from there, the dashboard user may search website users, and/or find client engagements, purchases, or the like by the website users. In some embodiments, a client attribution module 104 provides an interface (e.g., as part of a dashboard or the like) for a dashboard user to mark a website user as a client (e.g., in response to manually signing the website user up, receiving a paper or verbal engagement from the website user, or the like), then the dashboard user may run reports to determine which advertising sources, marketing efforts, or the like may be most effective, may be getting the most clients, or the like. In this manner, in some embodiments, a client attribution module 104 may enable a dashboard user to make data-based advertising decisions, intelligently spending their advertising budget.

In various embodiments, in order to track voice calls or the like, a client attribution module 104 may detect user clicks on a website (e.g., a user clicking a voice call link on the website to initiate a voice call), whether the user is on a mobile hardware computing device 102 (e.g., capable of making voice calls), or the like, tracking referral URLs, clicks, and actions as described above, including when the client clicks on a phone number to initiate a voice call. A client attribution module 104 may use one or more call tracking metrics to track incoming voice calls (e.g., monitoring voice calls to a phone number associated with the website and associating one or more data elements of a voice call with a user in response to matching a phone number, a caller identifier (ID), or the like with the user). For example, if a user is on a laptop or desktop hardware computing device 102 rather than a mobile hardware computing device 102 and the user makes a call, a client attribution module 104 may use one or more call tracking methods to match the call to a unique identifier already stored by the client attribution module 104 (e.g., based on a timestamp, a determined source or location, a stored phone number, or the like), allowing the client attribution module 104 to track voice calls, even if the voice call was made from a different hardware computing device 102 than the user used to interact with the site, and to correlate the voice calls with referral URLs, clicks, and other actions for the user.

In certain embodiments, a client attribution module 104 may collect one or more of a name, a phone number, an email address, or other contact information from a user in order for the user to begin an online chat, fill out an online form, and/or take another action. A client attribution module 104 may store the collected contact information with a unique identifier for the user, along with a transcript for the user's chat session, data from the filled out form, tracked referral URL, clicks, actions, or the like (e.g., even if the user does not complete or submit the online form or chat, leaving the online form or chat unsubmitted or the like). In this manner, a client attribution module 104 may track online chats and/or forms along with other metrics, even if the online chats and/or forms are not submitted by the user.

In various embodiments, a client attribution module 104 may be embodied as hardware, software, or some combination of hardware and software. In one embodiment, a client attribution module 104 may comprise executable program code stored on a non-transitory computer readable storage medium for execution on a processor of a hardware computing device 102, a backend server computing device 110, or the like. For example, a client attribution module 104 may be embodied as executable program code executing on one or more of a hardware computing device 102, a backend server computing device 110, a combination of one or more of the foregoing, or the like. In such an embodiment, various modules that perform the operations of a client attribution module 104 may be located on a hardware computing device 102, a backend server computing device 110, a combination of the two, or the like.

In various embodiments, a client attribution module 104 may be embodied as a hardware appliance that can be installed or deployed on a backend server computing device 110, on a user's hardware computing device 102 (e.g., a dongle, a protective case for a phone 102 or tablet 102 that includes one or more semiconductor integrated circuit devices within the case in communication with the phone 102 or tablet 102 wirelessly and/or over a data port such as a universal serial bus (USB) or a proprietary communications port, or another peripheral device), or elsewhere on the data network 106 and/or collocated with a user's hardware computing device 102. In certain embodiments, a client attribution module 104 may comprise a hardware computing device such as a secure hardware dongle or other hardware appliance device (e.g., a set-top box, a network appliance, or the like) that attaches to another hardware computing device 102, such as a laptop computer, a server, a tablet computer, a smart phone, or the like, either by a wired connection (e.g., a USB connection) or a wireless connection (e.g., Bluetooth®, Wi-Fi®, near-field communication (NFC), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of a client attribution module 104 may comprise a power interface, a wired and/or wireless network interface, a graphical interface (e.g., a graphics card and/or GPU with one or more display ports) that outputs to an electronic display device, and/or a semiconductor integrated circuit device as described below, configured to perform the functions described herein with regard to a client attribution module 104.

A client attribution module 104, in such an embodiment, may comprise a semiconductor integrated circuit device (e.g., one or more chips, die, or other discrete logic hardware), or the like, such as a field-programmable gate array (FPGA) or other programmable logic, firmware for an FPGA or other programmable logic, microcode for execution on a microcontroller, an application-specific integrated circuit (ASIC), a processor, a processor core, or the like. In one embodiment, a client attribution module 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of a client attribution module 104.

The semiconductor integrated circuit device or other hardware appliance of a client attribution module 104, in certain embodiments, comprises and/or is communicatively coupled to one or more volatile memory media, which may include but is not limited to: random access memory (RAM), dynamic RAM (DRAM), cache, or the like. In one embodiment, the semiconductor integrated circuit device or other hardware appliance of a client attribution module 104 comprises and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The one or more third-party providers 108, in one embodiment, may include one or more network accessible computing systems such as one or more web servers hosting one or more websites, an enterprise intranet system, an application server, an application programming interface (API) server, an authentication server, or the like. For example, a third-party provider 108 may comprise an entity associated with a website monitored by the client attribution module 104, or the like, such as a service provider, an ecommerce retailer, online marketers/advertisers, an attorney or law firm, an accountant or accounting firm, a doctor or other medical professional or medical facility, a dentist or dental facility, or other provider of goods and/or services.

A third-party provider 108 may allow users to create user accounts access and/or purchase goods and/or services via a website, or the like (e.g., from a server computing device of the third-party provider 108, from the backend server computing device 110, or the like). Accordingly, a third-party provider 108 may include an authorization system, such as a login element or page of a website, application, or similar front-end, where a user can provide credentials, such as a username/password combination, to access services, the user's orders, data, or the like.

A backend server computing device 110 may include one or more servers located remotely from the hardware computing devices 102 and/or the one or more third-party providers 108. A backend server computing device 110 may include at least a portion of a client attribution module 104, may comprise hardware of a client attribution module 104, may store executable program code of a client attribution module 104 in one or more non-transitory computer readable storage media, and/or may otherwise perform one or more of the various operations of a client attribution module 104 described herein for multisource client attribution. In some embodiments, a backend server computing device 110 may host a website for a third-party provider 108, may embed program code within a website of a third-party provider 108 (e.g., embedding a frontend client attribution module 104a into the website for execution within a browser of a hardware computing device 102 of a user, or the like).

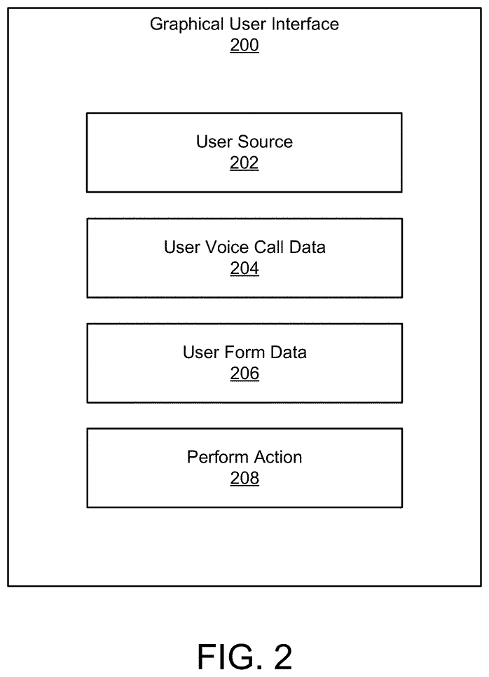

FIG. 2 depicts one embodiment of a graphical user interface (GUI) 200 for multisource client attribution. The GUI 200, in the depicted embodiment, includes a graphical display of sources 202 associated with users of a website, one or more data elements 204 of voice calls with users of the website, data 206 of user form and/or chat interactions with users of the website, and one or more user interface elements 208 enabling dashboard users of the GUI 200 to perform one or more actions related to users of the website. The GUI 200, in one embodiment, comprises a history of a user's visits to the website and/or a history of interactions of the user with the website.

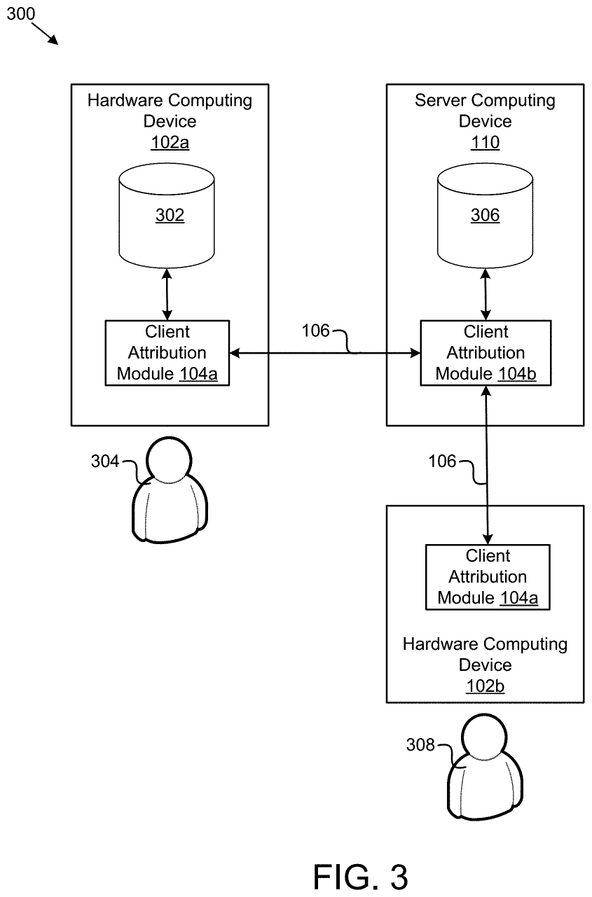

As described below with regard to FIG. 3, in some embodiments, a client attribution module 104 may be configured to display a GUI 200 as a dashboard to a user on an electronic display device of a hardware computing device 102 for the user. For example, a client attribution module 104 may display the GUI 200 from within an executable application installed on a hardware computing device 102, as a website within an internet browser executing on a hardware computing device 102, or the like.

In one embodiment, the displayed sources 202 associated with users of the website, may be displayed in aggregate, for multiple users (e.g., with numbers or groups of users from different sources 202, or the like). In a further embodiment, a user may drill down, search, filter, or the like to view a source 202 associated with a single, specific user. The displayed sources 202 associated with users of the website may include referring webpages or websites (e.g., a referring URL or the like), advertisements, campaigns, affiliates, search terms, geographic locations (e.g., based on internet protocol (IP) address, a database of Wi-Fi networks, cell tower triangulation, global positioning system (GPS) or other location sensors, or the like).

In one embodiment, the one or more data elements 204 of voice calls with users of the website may include dates of the voice calls, times of the voice calls, durations of the voice calls, phone numbers for the users, recipients of the voice calls, recordings of the voice calls, voice-to-text transcriptions of the voice calls, keywords from the voice calls, purchases and/or projects associated with the voice calls, notes associated with the voice calls, and/or other data elements 204 associated with the voice calls and/or the users.

In one embodiment, the data 206 of user form and/or chat interactions with users of the website may include submitted and/or unsubmitted text entries, uploaded files, uploaded images, uploaded videos, uploaded documents, contact information, email addresses, phone numbers, chat conversations, chat histories, abandoned shopping carts, selected services, partial or complete questionnaire results, and/or other data 206 provided by a user into an online form and/or chat user interface element of the website.

In one embodiment, the one or more user interface elements 208 enabling dashboard users of the GUI 200 to perform one or more actions related to users of the website include user interface elements 208 enabling one or more of sending an electronic offer to the user (e.g., an advertisement, a discount, a coupon, or the like), initiating a voice call with the user, sending a text message to the user, sending an email to the user, manually associating one or more previous interactions with the user, recording one or more notes associated with the user, marking the user as a client, requesting a review from the user, and/or other actions related to one or more users of the website. The GUI 200, in some embodiments, may enable dashboard users to perform bulk actions related to a plurality of users of the website, instead of or in addition to enabling individual actions for a specific user, or the like.

FIG. 3 depicts one embodiment of a system 300 for multisource client attribution. In the depicted embodiment, the system 300 includes a user hardware computing device 102a for a first user 304 and a dashboard hardware computing device 102b for a second user 308, each in communication with a server computing device 110 over a data network 106.

In one embodiment, the user hardware computing device 102a for the first user 304 includes a frontend client attribution module 104a and a local non-transitory computer readable storage medium 302 (e.g., volatile memory, non-volatile memory, or the like). The frontend client attribution module 104a may comprise executable program code installed on the hardware computing device 102a, executable program code embedded in a website and executed by an internet browser installed on the hardware computing device 102a, or the like to monitor the first user 304's interactions with the website (e.g., in cooperation with a backend client attribution module 104b, or the like).

The frontend client attribution module 104a, in certain embodiments, monitors for, detects, and/or stores one or more of a source associated with the user 304 of the website, one or more data elements of a voice call with the user 304 of the website, data of a user form and/or chat interaction with the user 304 in the local non-transitory computer readable storage medium 302 of the hardware computing device 102a for the user 304. For example, the frontend client attribution module 104a may store the data in a database, in JavaScript Object Notation (JSON) blobs or other JSON objects, in cookies, in files, in a cache, and/or in another data structure in the local non-transitory computer readable storage medium 302. The frontend client attribution module 104a may store a unique identifier for a user, a timestamp, one or more uniform resource locator (URL) parameters (e.g., a referring URL, an advertisement identifier, an advertisement group, information passed through link tracking, a source, an interaction history, a call history, a chat history, a form submission, unsubmitted form and/or chat data, data of a form interaction, data of a chat interaction, data elements of a voice call, or the like).

The frontend client attribution module 104a may integrate with a chat widget or other chat element of the website (e.g., may be compatible with a plurality of third-party chat widgets and/or plugins, or the like) to monitor chat interactions. In some embodiments, in order to detect data entered into multiple types and/or formats of website forms (e.g., with compatibility with websites for multiple third-party providers 108), the frontend client attribution module 104a may use a searching algorithm, or the like. The searching algorithm may start at an end of a form (e.g., a bottom end, a top end, or the like) and grab one or more form inputs on a webpage of the website, labels associated with the one or more form inputs, or the like and associates the form inputs from the user 304 with the labels and with the user 304 in the local non-transitory computer readable storage device 302.

The frontend client attribution module 104a may repeat the parsing process until each of multiple forms are located. The frontend client attribution module 104a may store the labels or other identifiers as keys to identify future inputs from other users (e.g., even if the form has no unique identifiers, input identifiers, or the like). The frontend client attribution module 104a, in some embodiments, may identify certain inputs of a form based on a parent of the inputs in the form. Identifying an input based on its parent, in certain embodiments, may provide consistent identification, speed up a setup process, or the like without requiring modification of the website to change or rewrite the form, which may be an intrusive process.

The frontend client attribution module 104a, in a further embodiment, may periodically upload stored data (e.g., a source associated with the user 304, one or more data elements of a voice call with the user 304, data of a user form interaction with the user 304, or the like) from the local non-transitory computer readable storage medium 302 to a non-transitory computer readable storage medium 306 of the server computing device 110 in response to a trigger event, such as the user 304 navigating to a different page of the website, starting an electronic chat via the website, filling out a form of the website, initiating a voice call via the website, a periodic timer (e.g., about every 1 second, 2 seconds, 3 seconds, 4 seconds, 5 seconds, 10 seconds, 30 seconds, 1 minute, 2 minutes, 5 minutes, 10 minutes, or the like), the user 304 performing an engagement event for the website, and/or another predefined trigger event.

In one embodiment, the dashboard hardware computing device 102b for the second user 308 includes a frontend client attribution module 104a. The frontend client attribution module 104a may comprise executable program code installed on the hardware computing device 102b, executable program code embedded in a website and executed by an internet browser installed on the hardware computing device 102b, or the like to display a GUI 200 to the second user 308 (e.g., in cooperation with a backend client attribution module 104b, or the like), substantially as described above with regard to FIG. 2.

In one embodiment, the server computing device 110 includes a backend client attribution module 104b and a backend non-transitory computer readable storage medium 306 (e.g., volatile memory, non-volatile memory, or the like). The backend client attribution module 104b may comprise executable program code installed on the hardware server computing device 110, hardware of the hardware server computing device 110, a combination of executable program code and hardware, or the like, to monitor the first user 304's interactions with the website (e.g., in cooperation with a frontend client attribution module 104a, or the like).

For example, in some embodiments, a frontend client attribution module 104a may monitor requests for the website on or from the hardware computing device 102a over the data network 106, monitor voice calls for the user 304 associated with the website and from the hardware computing device 102a, monitor form and/or chat interactions of the user 304 with the website, or the like and provide them to the backend client attribution module 104b on the hardware server computing device 110, which may associate the interactions with the user 304 (e.g., with a unique identifier for the user, with a username for the user, with an email address for the user, with a phone number for the user, or the like). The backend client attribution module 104b may provide the associated interactions to a GUI 200 displayed on an electronic display device of the hardware computing device 102b for the second user 308 (e.g., indexed by user 304 or the like). The second user 308 may comprise a dashboard user, an administrator, a third-party provider 108 user, or the like.

A client attribution module 104a, 104b may be configured to track a client status for the first user 304, and/or update the client status for the first user 304 in response to detecting an engagement event for the first user 304, such as the second user 308 manually marking the first user 304 as a client, receiving an electronic signature for the first user 304 on an electronic engagement agreement for the website, the first user 304 ordering a product or service using the website, and/or another engagement event for the first user 304. In this manner, in certain embodiments, the second user 308 may use the GUI 200 or the like to determine which sources and/or interactions are more likely to lead to qualified clients, may perform certain targeted actions with regard to clients and/or non-clients, or the like.

A client attribution module 104a, 104b, in some embodiments, may associate a previous voice call or other interaction of the first user 304 with the website based on a subsequent voice call or other interaction. For example, in response to a source associated with the first user 304, one or more data elements of a subsequent voice call with the first user 304, and/or data of a user form and/or chat interaction with the first user 304 indicating a phone number and/or a caller identifier (ID) associated with the previous voice call is associated with the first user 304 (e.g., by matching the phone number and/or caller ID with a database of previously unmatched voice calls or other interactions).

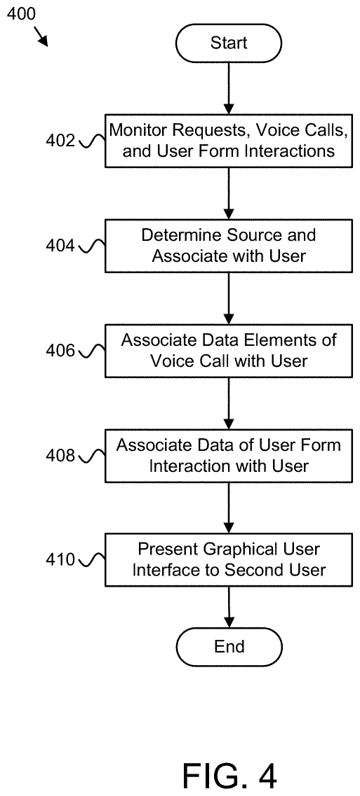

FIG. 4 depicts one embodiment of a method 400 for multisource client attribution. The method 400 beings and a client attribution module 104 monitors 402 requests for a website over a data network 106, voice calls associated with the website, and/or user form interactions associated with the website. A client attribution module 104, in response to a request for the website from a hardware computing device 102 of a user, determines 404 a source from which the user arrived at the website and associates the source with the user.

A client attribution module 104, in response to receiving a voice call from a hardware computing device 102 for the user, associates 406 one or more data elements of the voice call with the user. A client attribution module 104, in response to detecting a user form interaction from a hardware computing device 102 for the user, associates 408 data of the user form interaction with the user.

A client attribution module 104 presents 410 a graphical user interface 200 to a second user associated with the website on an electronic display device and the method 400 ends. The graphical user interface 200, in various embodiments, may comprise one or more of the source associated with the user, the one or more data elements of the voice call with the user, the data of the user form interaction with the user, and/or one or more user interface elements enabling the second user to perform one or more actions related to the user.

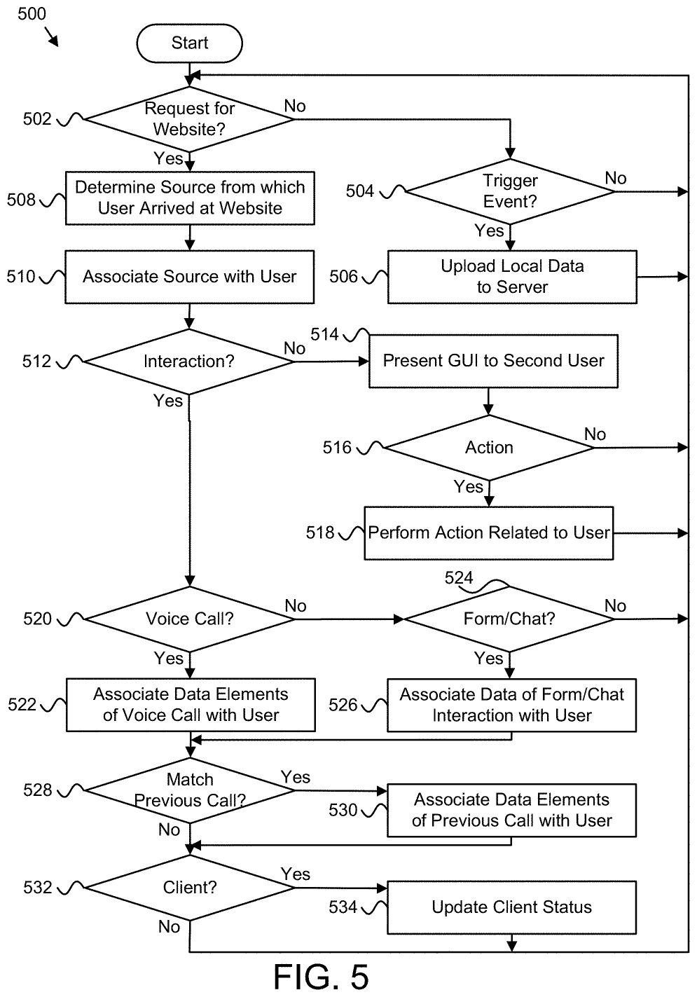

FIG. 5 depicts a further embodiment of a method 500 for multisource client attribution. The method 500 begins, and a client attribution module 104 monitors 502 requests for a website over a data network 106, voice calls associated with the website, and/or user form/chat interactions associated with the website. If the client attribution module 104 does not detect 502 a request for the website, the client attribution module 104 determines 504 whether a trigger event has occurred. If the client attribution module 104 determines 504 that a trigger event has occurred, the client attribution module 104 uploads 506 cached local data (e.g., a source associated with a user, one or more data elements of a voice call with a user, data of a user form/chat interaction with a user) from a local non-transitory computer readable storage medium of a hardware computing device 102 for a user to a non-transitory computer readable storage medium of a server computing device 110.

If the client attribution module 104 detects 502 a request for the website from a hardware computing device 102 for a user, the client attribution module 104 determines 508 a source from which the user arrived at the website and associates 510 the source with the user. The client attribution module 104 monitors 512 interactions of the user with the website. The client attribution module 104 presents 514 a graphical user interface to a second user associated with the website on an electronic display device (e.g., a GUI with a source associated with the user, one or more data elements of a voice call with the user, data of a user form/chat interaction with the user, user interface elements enabling the second user to perform one or more actions related to the user, or the like). If the client attribution module 104 determines 516 that the second user has interacted with a user interface element to perform an action related to the user, the client attribution module 104 performs 518 the action related to the user.

If the client attribution module 104 detects 512 an interaction and determines 520 that the interaction is a voice call from a hardware computing device 102 for the user, the client attribution module 104 associates 522 one or more data elements of the voice call with the user. If the client attribution module 104 determines 524 that the interaction is a form/chat interaction from a hardware computing device 102 for the user, the client attribution module 104 associates 526 data of the user form/chat interaction with the user.

The client attribution module 104 determines 528 whether data of the voice call 520 and/or the form/chat interaction match data from a previously unmatched voice call with the user, and if so, associates 530 the previous call with the user. The client attribution module 104 tracks 532 a client status for the user, and in response to detecting 532 an engagement event for the user (e.g., the second user manually marking a user as having engaged as a client, receiving an electronic signature for the user on an electronic engagement agreement for the website, the user ordering a product or service using the website, or the like), updates 534 the client status for the user. The method 500 continues with the client attribution module 104 monitoring 502 requests for the website, monitoring 512 user interactions with the website, or the like.

A means for monitoring requests for a website over a data network 106, voice calls associated with the website, and/or user form interactions associated with the website, in various embodiments, may include one or more of a client attribution module 104, a filter driver, a hardware computing device 102, a hardware server computing device 110, a network interface device, a processor, an ASIC, an FPGA, a script or other executable program code inserted into one or more webpages of the website, and other hardware devices and/or executable program code stored on a non-transitory computer readable storage medium. Other embodiments may include similar or equivalent means for monitoring requests for a website over a data network 106, voice calls associated with the website, and/or user form interactions associated with the website.

A means for determining sources from which users arrived at a website and associating the sources with the users, in various embodiments, may include one or more of a client attribution module 104, a hardware computing device 102, a hardware server computing device 110, a network interface device, a processor, an ASIC, an FPGA, a script or other executable program code inserted into one or more webpages of the website, a database or other data structure indexed by unique identifiers for the users, a local non-transitory computer readable storage medium 302, a server non-transitory computer readable storage medium 306, and other hardware devices and/or executable program code stored on a non-transitory computer readable storage medium. Other embodiments may include similar or equivalent means for determining sources from which users arrived at a website and associating the sources with the users.

A means for associating one or more data elements of voice calls with users, in various embodiments, may include one or more of a client attribution module 104, a hardware computing device 102, a hardware server computing device 110, a network interface device, a voice call server device, audio processing hardware, a digital to analog converter (DAC), an analog to digital converter (ADC), a digital signal processor (DSP), a processor, an ASIC, an FPGA, a script or other executable program code inserted into one or more webpages of the website, a database or other data structure indexed by unique identifiers for the users, a local non-transitory computer readable storage medium 302, a server non-transitory computer readable storage medium 306, and other hardware devices and/or executable program code stored on a non-transitory computer readable storage medium. Other embodiments may include similar or equivalent means for associating one or more data elements of voice calls with users.

A means for associating data of user form/chat interactions with users, in various embodiments, may include one or more of a client attribution module 104, a hardware computing device 102, a hardware server computing device 110, a network interface device, a processor, an ASIC, an FPGA, a script or other executable program code inserted into one or more webpages of the website, a database or other data structure indexed by unique identifiers for the users, a local non-transitory computer readable storage medium 302, a server non-transitory computer readable storage medium 306, a form user interface element, a chat widget, and other hardware devices and/or executable program code stored on a non-transitory computer readable storage medium. Other embodiments may include similar or equivalent means for means for associating data of user form/chat interactions with users.

A means for presenting a graphical user interface to a different user associated with a website, in various embodiments, may include one or more of a client attribution module 104, a hardware computing device 102, a hardware server computing device 110, a network interface device, a processor, an ASIC, an FPGA, a script or other executable program code inserted into one or more webpages of the website, an electronic display device, an internet browser, and other hardware devices and/or executable program code stored on a non-transitory computer readable storage medium. Other embodiments may include similar or equivalent means for presenting a graphical user interface to a different user associated with a website.

A means for enabling a different user to perform one or more actions related to users, in various embodiments, may include one or more of a client attribution module 104, a filter driver, a hardware computing device 102, a hardware server computing device 110, a network interface device, a processor, an ASIC, an FPGA, a script or other executable program code inserted into one or more webpages of the website, an internet browser, an email server, a voice call server, and other hardware devices and/or executable program code stored on a non-transitory computer readable storage medium. Other embodiments may include similar or equivalent means for enabling a different user to perform one or more actions related to users.

A means for tracking client statuses for users and for updating the client statuses for the users in response to detecting engagement events for the users, in various embodiments, may include one or more of a client attribution module 104, a hardware computing device 102, a hardware server computing device 110, a network interface device, a processor, an ASIC, an FPGA, a script or other executable program code inserted into one or more webpages of the website, a database or other data structure indexed by unique identifiers for the users, an internet browser, an engagement agreement data structure, an ecommerce platform, and other hardware devices and/or executable program code stored on a non-transitory computer readable storage medium. Other embodiments may include similar or equivalent means for tracking client statuses for users and for updating the client statuses for the users in response to detecting engagement events for the users.

A means for associating previous voice calls with users, in various embodiments, may include one or more of a client attribution module 104, a hardware computing device 102, a hardware server computing device 110, a network interface device, a voice call server device, audio processing hardware, a digital to analog converter (DAC), an analog to digital converter (ADC), a digital signal processor (DSP), a processor, an ASIC, an FPGA, a script or other executable program code inserted into one or more webpages of the website, a database or other data structure indexed by unique identifiers for the users, a local non-transitory computer readable storage medium 302, a server non-transitory computer readable storage medium 306, and other hardware devices and/or executable program code stored on a non-transitory computer readable storage medium. Other embodiments may include similar or equivalent means for associating previous voice calls with users.

A means for storing one or more sources, data elements of voice calls, and/or data of user form/chat interactions associated with users, in various embodiments, may include one or more of a client attribution module 104, a hardware computing device 102, a hardware server computing device 110, a processor, an ASIC, an FPGA, a script or other executable program code inserted into one or more webpages of the website, a database or other data structure indexed by unique identifiers for the users, a local non-transitory computer readable storage medium 302, a server non-transitory computer readable storage medium 306, and other hardware devices and/or executable program code stored on a non-transitory computer readable storage medium. Other embodiments may include similar or equivalent means for storing one or more sources, data elements of voice calls, and/or data of user form/chat interactions associated with users.

A means for uploading one or more sources, data elements of voice calls, and/or data of user form/chat interactions associated with users to a non-transitory computer readable storage medium 306 of a server computing device 110, in various embodiments, may include one or more of a client attribution module 104, a hardware computing device 102, a hardware server computing device 110, a network interface device, a network router device, a network switch device, a processor, an ASIC, an FPGA, a script or other executable program code inserted into one or more webpages of the website, a database or other data structure indexed by unique identifiers for the users, a local non-transitory computer readable storage medium 302, a server non-transitory computer readable storage medium 306, and other hardware devices and/or executable program code stored on a non-transitory computer readable storage medium. Other embodiments may include similar or equivalent means for uploading one or more sources, data elements of voice calls, and/or data of user form/chat interactions associated with users to a non-transitory computer readable storage medium 306 of a server computing device 110.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a hardware server computing device comprising a processor and a non-transitory computer readable storage medium storing program code executable by the processor to perform operations comprising:
monitoring requests for a website over a data network, voice calls associated with the website, and user form interactions associated with the website;
in response to a request for the website from a hardware computing device for a user, determining a source from which the user arrived at the website and associating the source with the user;
in response to receiving a voice call from a hardware computing device for the user, associating one or more data elements of the voice call with the user;
in response to detecting a user form interaction from a hardware computing device for the user, associating data of the user form interaction with the user; and
presenting a graphical user interface to a second user associated with the website on an electronic display device, the graphical user interface comprising the source associated with the user, the one or more data elements of the voice call with the user, the data of the user form interaction with the user, and one or more user interface elements enabling the second user to perform one or more actions related to the user.

2. The apparatus of claim 1, the operations further comprising tracking a client status for the user and updating the client status for the user in response to detecting an engagement event for the user.

3. The apparatus of claim 2, wherein the engagement event comprises receiving an electronic signature for the user on an electronic engagement agreement for the website.

4. The apparatus of claim 2, wherein the engagement event comprises the user ordering a product or service using the website.

5. The apparatus of claim 1, the operations further comprising associating a previous voice call with the user in response to one or more of the source associated with the user, the one or more data elements of the voice call with the user, and the data of the user form interaction with the user indicating one or more of a phone number and a caller identifier (ID) associated with the previous voice call is associated with the user.

6. The apparatus of claim 1, the operations further comprising storing one or more of the source associated with the user, the one or more data elements of the voice call with the user, and the data of the user form interaction with the user in a local non-transitory computer readable storage medium of a hardware computing device for the user and uploading the one or more of the source associated with the user, the one or more data elements of the voice call with the user, the data of the user form interaction with the user to the non-transitory computer readable storage medium of the server computing device in response to one or more for the user navigating to a different page of the website, starting an electronic chat via the website, filling out a form of the website, and initiating a voice call via the website.

7. The apparatus of claim 1, wherein the source associated with the user comprises one or more of an electronic advertisement the user clicked, one or more search keywords the user entered into a search engine, a webpage that linked the user to the website, and a geographic location for the user.

8. The apparatus of claim 1, wherein the graphical user interface comprises a history of the user's visits to the website and a history of interactions of the user with the website.

9. The apparatus of claim 1, wherein associating the source, the one or more data elements of the voice call, and the data of the user form interaction with the user comprises associating the source, the one or more data elements of the voice call, and the data of the user form interaction with a unique identifier associated with the user.

10. The apparatus of claim 1, wherein the voice calls associated with the website comprise voice calls initiated by the user clicking a voice call link on the website.

11. The apparatus of claim 1, wherein the voice calls associated with the website comprise voice calls to a phone number associated with the website and the one or more data elements of the voice call are associated with the user in response to matching one or more of a phone number and a caller identifier (ID) with the user.

12. The apparatus of claim 1, wherein the user form interaction comprises data entered by the user into a field of a form user interface element but left unsubmitted by the user.

13. The apparatus of claim 1, wherein the user form interaction comprises an interaction with a chat form of the website.

14. The apparatus of claim 1, wherein the one or more actions associated with the user comprise one or more of sending an electronic offer to the user, initiating a voice call with the user, sending a text message to the user, sending an email to the user, manually associating one or more previous interactions with the user, and recording one or more notes from the second user associated with the user.

15. A system comprising:
a hardware server computing device comprising a processor and a non-transitory computer readable storage medium storing program code executable by the processor to perform operations comprising:
monitoring requests for a website over a data network, voice calls associated with the website, and user form interactions associated with the website;
in response to requests for the website from hardware computing devices for users, determining sources from which the users arrived at the website and associating the sources with the users;
in response to receiving voice calls from hardware computing devices for the users, associating one or more data elements of the voice calls with the users;
in response to detecting user form interactions from hardware computing devices for the users, associating data of the user form interactions with the users; and
presenting a graphical user interface to a different user associated with the website on an electronic display device, the graphical user interface comprising the sources associated with the users, the one or more data elements of the voice calls with the users, the data of the user form interactions with the users, and one or more user interface elements enabling the different user to perform one or more actions related to the users; and
a plurality of client attribution modules executing on hardware computing devices for the users, the client attribution modules configured to store one or more of the sources associated with the users, the one or more data elements of the voice calls with the users, and the data of the user form interactions with the users in local non-transitory computer readable storage mediums and to periodically upload the one or more of the sources associated with the users, the one or more data elements of the voice calls with the users, and the data of the user form interactions with the users to the non-transitory computer readable storage medium of the server computing device in response to one or more trigger events.

16. The system of claim 15, wherein the plurality of client attribution modules comprise program code embedded in pages of the website and executing in web browsers for the users.

17. An apparatus comprising:
means for monitoring requests for a website over a data network, voice calls associated with the website, and user form interactions associated with the website;
means for determining, in response to requests for the website from hardware computing devices for users, sources from which the users arrived at the website and associating the sources with the users;
means for associating, in response to receiving voice calls from hardware computing devices for the users, one or more data elements of the voice calls with the users;
means for associating, in response to detecting user form interactions from hardware computing devices for the users, data of the user form interactions with the users; and
means for presenting a graphical user interface to a different user associated with the website on an electronic display device, the graphical user interface comprising the sources associated with the users, the one or more data elements of the voice calls with the users, the data of the user form interactions with the users, and one or more user interface elements enabling the different user to perform one or more actions related to the users.

18. The apparatus of claim 17, further comprising means for tracking client statuses for the users and for updating the client statuses for the users in response to detecting engagement events for the users.

19. The apparatus of claim 17, further comprising associating previous voice calls with the users in response to one or more of the sources associated with the users, the one or more data elements of the voice calls with the users, and the data of the user form interactions with the users indicating one or more of phone numbers and caller identifiers (IDs) associated with the previous voice calls are associated with the users.

20. The apparatus of claim 17, further comprising means for storing one or more of the sources associated with the users, the one or more data elements of the voice calls with the users, and the data of the user form interactions with the users in local non-transitory computer readable storage mediums of hardware computing devices for the users and uploading the one or more of the sources associated with the users, the one or more data elements of the voice calls with the users, the data of the user form interactions with the users to the non-transitory computer readable storage medium of the server computing device in response to one or more for the users navigating to different pages of the website, starting electronic chats via the website, filling out forms of the website, and initiating voice calls via the website.
